(19) United States
(12) Patent Application Publication
(10) Pub. No.: US 2025/0172035 A1
(43) Pub. Date: May 29, 2025

(54) DOOR PANEL AND DOOR PANEL SYSTEMS AND METHODS

(71) Applicant: Masonite Corporation, Tampa, FL (US)

(72) Inventors: Darshit THAKKAR, St. Charles, IL (US); Christopher J. REINKE, Boston, MA (US); Apollo PAREDES, Livonia, MI (US); Steven B. SWARTZMILLER, Batavia, IL (US); Cory J. SORICE, La Grange, IL (US)

(21) Appl. No.: 18/962,089

(22) Filed: Nov. 27, 2024

Related U.S. Application Data
(60) Provisional application No. 63/604,047, filed on Nov. 29, 2023.
(60) Provisional application No. 63/604,052, filed on Nov. 29, 2023.

(51) Int. Cl. E06B 3/70

(52) U.S. Cl. CPC E06B 3/7001; E06B 2003/7011

(57) ABSTRACT

A door panel and/or door panel systems and methods are provided that facilitate facile swapping of a primary panel for a stile and rails door which includes a panel retaining component provided in at least plural positions on the plural stiles or rails, wherein the retaining component is configured to allow replacement of the primary panel without disassembly of the stiles and rails themselves.

### CROSS-REFERENCE TO RELATED APPLICATIONS

This application claims the benefit of U.S. Application No. 63/604,047, filed Nov. 29, 2023, and claims the benefit of U.S. Application No. 63/604,052, filed Nov. 29, 2023, the contents of both which are incorporated by reference herein in their entirety.

### FIELD

The present invention is generally related to door panels and door panel systems and methods that provide mechanisms for facile swapping of primary or supplemental door panels of varying types, design, and function.

### BACKGROUND

Doors are an essential part of every building, providing residents with access, security, aesthetics, etc. Interior and exterior doors may be ordered from in a variety of door stock styles, panel patterns, etc. While these stock doors may be painted by a consumer according to preference, once the door is installed and finished, there is little that can be done to further customize or personalize any given door.

Certain doors are known that are modular, e.g., PCT Publication No. WO2018/091896 to Simmons; however, these are framed doors that require disassembly of the frame itself in order to remove and replace interior panels.

What is needed in the art are mechanisms that allow customization of doors with facile swapping of primary or supplemental panels at the time of or after ordering particular/stock doors for a residence or commercial space.

### SUMMARY

The present disclosure overcomes the disadvantages of the art by providing a door panel and/or door panel systems and methods that facilitate facile swapping of primary or secondary panels for a door. In exemplary aspects, only non-professional effort is required to install or swap panels for any given door, by virtue of an easy panel swapping mechanism.

In a first exemplary aspect and in contrast with the prior art, which requires disassembly of a frame component, a primary panel is replaceable via removal of a retaining member, gasket or deformable or removable block member (e.g., plural shims, tabs, blocks, etc.) that are provided at least partial around the primary panel.

In other exemplary embodiments, a supplemental panel can be, in the alternative or additionally (even if a primary panel is replaced), affixed to a door via one or more fasteners, such as magnetic fasteners, lock and pin fasteners, hook and loop fasteners, e.g., Velcro or others, and in particular exemplary embodiments, sleek, thin or ultra thin profile hook and loop fasteners or tapes, etc., to unobtrusively and easily allow mounting and replacement of one or more supplemental panels on a stock door. A pattern or template for installation of a mounting solution is provided in exemplary solutions, in general or specific to particular doors or particular door portions (which requires at least some knowledge of that particular door or door pattern), e.g., by providing a template for drilling holes as part of a system or method for installation of secondary panels, by providing an indication as to where to place magnets, hook and loop fasteners, etc., e.g., for doors that are already owned by a consumer, but which may be modified, accented, etc., via facile application of screws, magnets, hook and loop attachments, etc. While certain embodiments describe a single fastener or system of fasteners for attachment of a panel, it should be recognized that a secondary fastener mechanism or system of fastening can be incorporated to further ensure that the panel is in place or will not fall off.

In further exemplary embodiments, panel systems and panel methods for the supplemental panel further include alignment mechanisms, such as fingers or offsets, etc., used to align a panel into a recessed portion of the door (e.g., into one contoured panel of a stock door). In such exemplary embodiments, these serve to help position a supplemental panel, while reducing the risk of damaging the door itself. These fingers or offsets may be initially provided for any desired secondary panel, and can either be incorporated into the attachment as a spacer, or can be discarded (e.g., pulled off and dropped to the side) once the panel is mostly in place over the panel portion of the door.

In further exemplary embodiments the (supplemental) panel(s) themselves are contoured according to one or more panel aspects of a stock door in order to more seamlessly fit a particular door or door panel pattern. In such cases, the attachment mechanism(s), e.g., ultra-thin hook and loop fasteners, can be shaped and within the stock panel pattern itself so as to hold the supplemental panel in place without it being an obvious modification or so as to hide the attachment mechanism itself.

In any exemplary embodiment, the supplemental panel can either accentuate a stock door theme, pattern, shape, color, material or texture/finish (because it carries a similar property), or can modify that theme, pattern, shape, color, material or texture/finish in a certain way by deviating from or adding on to the stock design, etc. In further exemplary embodiments, the supplemental panel can provide functionality beyond the aesthetic, whether it be for acoustic purposes, electronic or networking purposes, as a hanger, a whiteboard, a display piece, or otherwise. In the same vein, a replaced primary panel in accordance with the present disclosure can also conform to or deviate from a given style, theme, texture, and/or provide function, etc., to or for the door or door portion.

In further exemplary embodiments, a web interface provides for an ordering system that identifies a desired door design and allows for customization or personalization of panels as described above or further in the present disclosure.

Other aspects of the invention, including devices, systems, methods and the like which constitute part of the invention, will become more apparent upon reading the following detailed description of various exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, assist in explaining the principles of the invention. In such drawings:

FIG. 1A is a front elevation view of a stock door in accordance with exemplary aspects of the present disclosure;

FIG. 1B is a front elevation view of an exemplary supplemental panel for a door, such as one from FIG. 1A in accordance with exemplary aspects of the present disclosure;

FIG. 1C is a front elevation view of an exemplary supplemental panel or plural panels for a door, such as one from FIG. 1A in accordance with exemplary aspects of the present disclosure;

FIG. 1D is a front elevation view of an exemplary door with supplemental panels installed, in accordance with exemplary aspects of the present disclosure;

FIG. 2A is a schematic view of an exemplary pin used to install a supplemental panel, in accordance with exemplary aspects of the present disclosure;

FIG. 2B is a front elevation view of asymmetric panel installation points on an exemplary door, in accordance with exemplary aspects of the present disclosure;

FIG. 3A is a front elevation view of an installed supplemental door panel including alignment mechanisms, in accordance with exemplary aspects of the present disclosure;

FIG. 3B a perspective view of an installed supplemental door panel including alignment mechanisms, in accordance with exemplary aspects of the present disclosure;

FIG. 4A is a cutaway view of an exemplary geometry configured supplemental panel installed in a contoured door panel, in accordance with exemplary aspects of the present disclosure;

FIG. 4B is a cutaway view of another exemplary geometry configured supplemental panel installed in a contoured door panel, in accordance with exemplary aspects of the present disclosure;

FIG. 5 is an exemplary flowchart and user interface illustrating custom ordering of supplement panel(s), in accordance with exemplary aspects of the present disclosure;

FIG. 6 is a schematic showing various exemplary primary or supplemental panel features, functions or design aspects;

FIG. 7 illustrates a perspective view of a portion of a stile and rail type door, in accordance with exemplary aspects of the present disclosure;

FIG. 8 illustrates a cutaway view of a first exemplary embodiment of a stile and rail type door with an easily removable primary panel, in accordance with exemplary aspects of the present disclosure; and

FIG. 9 illustrates a cutaway view of a second exemplary embodiment of a stile and rail type door with an easily removable primary panel, in accordance with exemplary aspects of the present disclosure.

### DETAILED DESCRIPTION OF EXEMPLARY EMBODIMENTS

Reference will now be made in detail to the exemplary embodiments and exemplary methods as illustrated in the accompanying drawings, in which like reference characters designate like or corresponding parts throughout the drawings. It should be noted, however, that the invention in its broader aspects is not necessarily limited to the specific details, representative materials and methods, and illustrative examples shown and described in connection with the exemplary embodiments and exemplary methods.

This description of exemplary embodiments is intended to be read in connection with the accompanying drawings, which are to be considered part of the entire written description. In the description, relative terms such as “horizontal,” “vertical,” “front,” “rear,” “upper”, “lower”, “top” and “bottom” as well as derivatives thereof (e.g., “horizontally,” “vertically,” “downwardly,” “upwardly,” etc.) should be construed to refer to the orientation as then described or as shown in the drawing figure under discussion and to the orientation relative to a vehicle body. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixedly (i.e., non-moveably) connected together. Additionally, the word “a” and “an” as used in the claims means “at least one” and the word “two” as used in the claims means “at least two”.

As we have noted, the present disclosure describes a door panel and/or door panel systems and methods that facilitate facile swapping of primary or secondary panels for a door. In exemplary aspects, only non-professional effort is required to install or swap panels for any given door, by virtue of an easy panel swapping mechanism.

It should be understood that the term “panel” does not include any specifically required geometry, and indeed may be any object that is supported by at least one attachment point (or mechanism). In other exemplary embodiments, a panel is supported by at least two attachment points. In further exemplary embodiments, a panel is supported by at least three attachment points. In additional exemplary embodiments, a panel is supported by at least four attachment points. Exemplary panels include racks for toys, sound dampening materials for speakers or for noise dampening in general, utility racks, whiteboards or other student aids, poster panels (obviating a need to adhere or tack posters to the actual door), electronics, e.g., wireless or other network or communications repeaters, routers or other equipment, clocks, cameras, displays, racks, simple canvas or other fabric, for aesthetics or otherwise, any other aesthetic attachment, in line with the contours of the door or door panel geometry, theme, texture, etc., or not in line with those contour aspects.

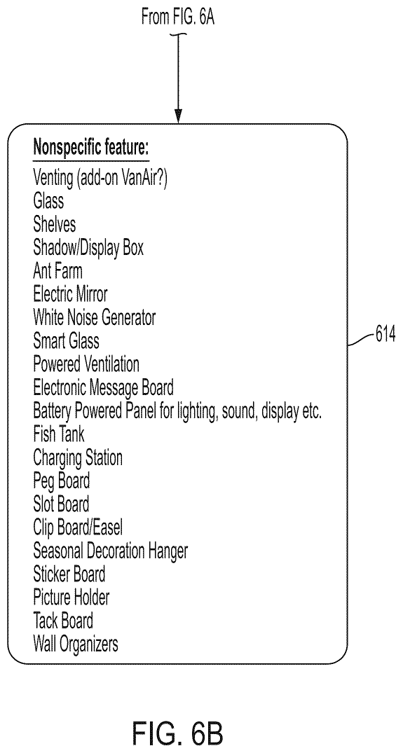

With reference to FIG. 7, a stile and rail type door is generally illustrated at 700. Though a full door is not illustrated, it is generally understood that the stiles are the vertical members, such as stile member 714, with rails being horizontal, as for rail member 712. As this is an assembled construction, there is a join between the two at 716. Primary panel 718 rests and is secured between the stiles and rails (which surround the panel 718).

An exemplary embodiment of an easily removable primary panel for a stile and rail door is illustrated generally at 800, which includes a rail 812 (though such a construction could also be provided on at least a portion of a stile), a portion of which is illustrated with a removeable retaining component 820, which can be, e.g., a gasket, one or more shims, pins or other edge material for easy replacement of a primary door panel that are complementary to holes or grooves in the door around the panel and which are configured to facilitate removal of the retaining component and replaceable panel, without disassembly of any door frame components.

The illustrated exemplary removable retaining component 820 holds the primary panel 818 in place via molded (and shaped in this case to at least partially complement the geometry of the opposite side of the primary panel) (in this case exemplary, illustrated) gasket 820. In exemplary aspects, the gasket is held in place using a foot 824, which can be a material having varying shapes or durometer hardnesses to be compatible with channel 822 in the rail 812 (or e.g., in the stile in the alternative or as well).

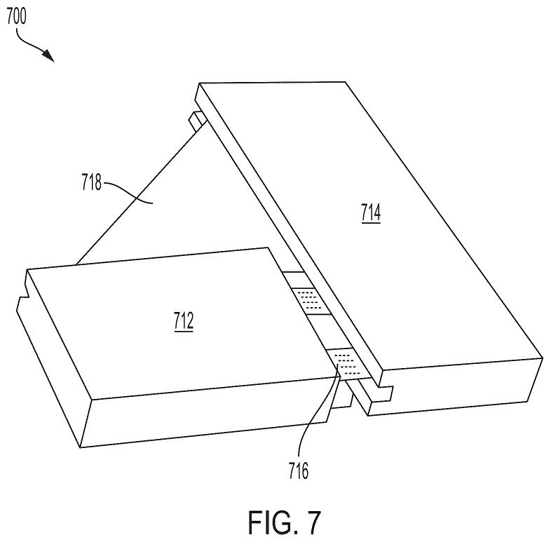

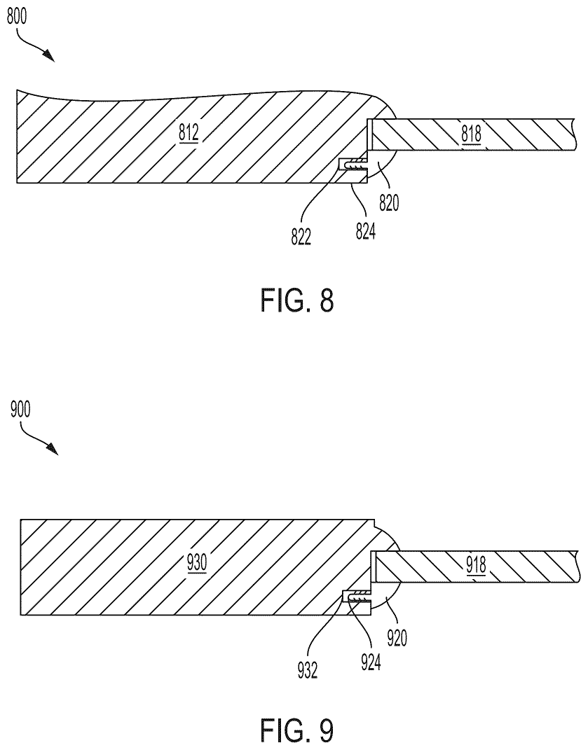

FIG. 9 illustrates (generally at 900) a stile 930 having a channel 932 that seats a protruding member 924 of a gasket 920 to seat such a primary panel 918. As with FIG. 8, the retaining component 920 complements the geometry of the stile molding opposite of the primary panel.

While a gasket member is illustrated in FIGS. 7-9, we note that materials of different hardnesses, different shapes, styles, etc., are contemplated for such retaining component, including hardnesses that extend up to a hardness that approximate pins or rib like materials, at least for members 824 and 924. Further, materials 820 and 824 or 920 and 924 can have different or graduated hardnesses, as desired to secure the panel in place but also to provide flexibility and ease of removal or reinstallation after replacement with a different primary panel. Finally, material 820 or 920 can incorporate any of the mounting materials (e.g., magnets or other materials) to allow for installation of a further supplemental panel thereover.

Such supplemental panels are further described as per the below and other sections of the present disclosure. While it is noted below, we again note that any of the configurations, be it design or function, described below with regard to panels in general or supplemental panels applies as well to the above embodiments that consider facile replacement of primary panels within a door.

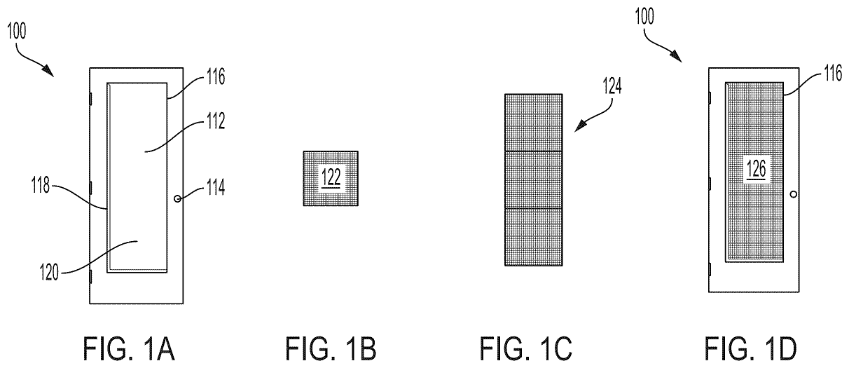

With reference to FIGS. 1A-1D, an example of a panel or panel system or method is illustrated generally at 100. FIG. 1A is a front elevation view of a standard or stock door 112, with door hardware 114, a contoured portion 116, e.g., an orthogonal, stepped, beveled, complex shape, etc., portion extending to and at least partially surrounding an at least partially recessed panel portion 118 that also has a recessed flat, or base, portion 120. While a single panel base 120 is illustrated, it should be recognized that the door may come in any desired style, e.g., with symmetric panels, non-symmetric panels, multiple different panels, functional panels, e.g., smart glass panels, etc. The present disclosure provides for replacement or supplemental panels, such as are illustrated in FIGS. 1B-1D for any given door, as in FIG. 1A.

FIG. 1B shows an exemplary supplemental panel 122 (without particular reference to style, though we note that any given panel described herein can be style specific). FIG. 1C shows a set of panels 124, which can be a collection of individual panels or a styled, attached set or single panel configured to fit a particular door, as in FIG. 1A. FIG. 1D shows an exemplary panel 126 (or collective panels) installed on/in the door 100 over the flat portion 120 (in FIG. 1A), and indeed in this example over the contoured portion 116.

We note that the contouring of doors can have any number of patterns, bevels, etc. In exemplary embodiments, the stock door panels, and the geometries of the bevels around the panels can have any number of geometries. In exemplary embodiments, a supplemental panel is provided with a complementary geometry or shape to the panel and bevel for any particular door overall or any door panel therein. Further, where the supplemental panel is provided that does not cover the entirety of the primary, stock door panel, in exemplary embodiments, at least a portion of the supplemental panel (e.g., at attachment points) is configured with a complementary geometry to the panel or bevel for any particular door overall or any door panel therein. In such a way, particular supplemental panels can be “customized” according to the stock door overall, or to particular panel aspects that form a part of that stock door. Such exemplary embodiments may provide a seamless (installed look) supplemental panel customization or personalization of the existing stock door (though again, we note that other exemplary embodiments contemplate supplemental panels that diverge from the general design of the door or door aspect).

In a first exemplary aspect and in contrast with the prior art, which requires disassembly of a frame component, a supplemental panel is affixed to a door via one or more fasteners, such as magnetic fasteners, lock and pin fasteners, hook and loop fasteners, e.g., Velcro or others, and in particular exemplary embodiments, sleek, thin or ultra thin profile hook and loop fasteners or tapes, etc., to unobtrusively and easily allow mounting and replacement of one or more supplemental panels on a stock door. Other exemplary fasteners include, but are not limited to, screws, pins, grommets, etc.

In exemplary embodiments, a pattern or template for installation of a mounting solution is provided, e.g., as part of a kit or as a supplemental guide for installation for a door, in general or specific to particular doors or particular door portions (which requires at least some knowledge of that particular door or door pattern), e.g., by providing a template for drilling holes as part of a system or method for installation of secondary panels, by providing an indication as to where to place magnets, hook and loop fasteners, etc., e.g., for doors that are already owned by a consumer, but which may be modified, accented, etc., via facile application of screws, magnets, hook and loop attachments, etc.

While certain embodiments describe a single fastener or system of fasteners for attachment of a panel, it should be recognized that a secondary fastener mechanism or system of fastening can be incorporated to further ensure that the panel is in place or will not fall off.

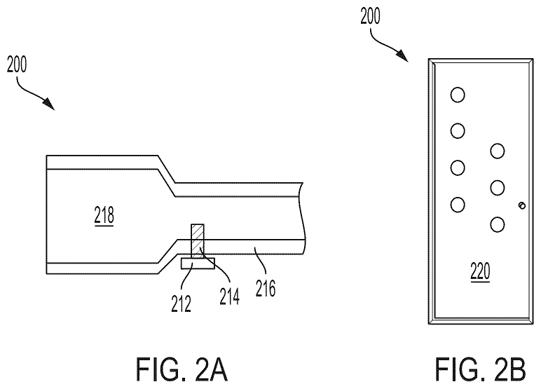

FIGS. 2A-2B illustrate exemplary additional supplemental panel mounting configurations generally at 200, e.g., in FIG. 2A, with pin 212 in place on a hole 214 in the door generally over the primary panel 216 of the door 218 (without a supplemental panel in place). FIG. 2B illustrates a door 220, with asymmetric mount points 222 for a panel (not shown). In some exemplary embodiments, the mounting points are generally on the panel itself, e.g., below a contour. In other exemplary embodiments, the mounting points are on or within that contour.

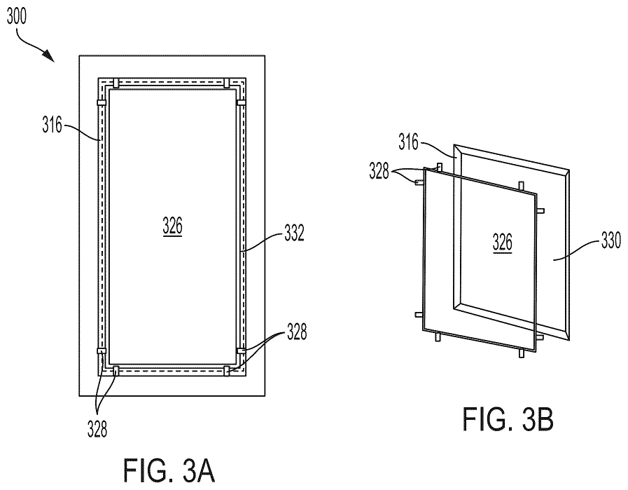

In further exemplary embodiments, panel systems and panel methods further include alignment mechanisms, such as fingers or offsets, etc., used to align a panel into a recessed portion of the door (e.g., into one contoured panel of a stock door). FIG. 3A illustrates an exemplary door at 300 having a beveled portion 316. A supplemental panel 326 is installed over a primary panel (not shown, except for beveled portion 316. Alignment fingers or offsets 328, which are labeled at the bottom of door 300, though they also exist in this embodiment at the top of the door, assist in positioning the supplemental panel 326, while reducing the risk of damaging the door itself. These fingers or offsets may be initially provided for any desired secondary/supplemental panel; and can either be incorporated into the attachment as a spacer, or can be discarded (e.g., pulled off and dropped to the side) once the panel is mostly in place over the panel portion of the door). Further, the fingers or offsets themselves can be contoured to the geometry or style of any particular stock door panel. In exemplary embodiments, the supplemental panel, with the assistance of the alignment mechanisms, show a reveal line 332 between the perimeter of the supplemental panel 326 and the bevel 316 of the door slab panel, which either provides aesthetic emphasis for the supplemental panel or assists in the installation of the supplemental panel itself.

FIG. 3B shows a supplemental panel 326, with alignment mechanisms, e.g., at 328, which assist installation over bevel 316 of an individual panel portion 330 of any particular door (not shown).

In further exemplary embodiments the panel(s) themselves are contoured according to one or more panel aspects of a stock door in order to more seamlessly fit a particular door or door panel pattern. In such cases, the attachment mechanism(s), e.g., ultra-thin hook and loop fasteners, can be shaped and within the contours of the stock panel pattern itself so as to hold the supplemental panel in place without it being an obvious modification or so as to hide the attachment mechanism itself. In general, exemplary fasteners (which may be provided on, installed within from the factory, installed within by the user, or otherwise underneath the door skin itself) include low profile fasteners, such as are described immediately above and include hook and loop fasteners, such as Velcro™ Sleek or thin profile tapes, Velcro™ Ultra-thin profile tapes, or other hook and loop fasteners, magnetic fasteners, including high strength magnets, adhesives, pins, screws, etc. In exemplary embodiments, the fasteners include complementary portions in corresponding locations for installation of the supplemental panel and the primary door panel and/or the beveled portion thereof.

In any exemplary embodiment, the supplemental panel can either accentuate a stock door theme, pattern, shape, color, material or texture/finish (because it carries a similar property), or can modify that theme, pattern, shape, color, material or texture/finish in a certain way by deviating from or adding on to the stock design, etc. In further exemplary embodiments, the supplemental panel can provide functionality beyond the aesthetic, whether it be for acoustic purposes, electronic or networking purposes, as a hanger, a whiteboard, a display piece, or otherwise.

As we have noted, the contouring of any given panel can (optionally, but not necessarily) be configured to match the contouring of any given door portion. For example, an exemplary interior door (or an exterior or other door, e.g., where an interior portion is customized or accented in any way described herein) may have one panel, with a beveled or otherwise shaped outer contour, or 2-6 or more panel portions within that door space, according to aesthetic preference. Exemplary aspects described herein provide either a universal or custom supplemental panel for one or more of such panel portions, which supplemental panel is easily installed (e.g., via a DIY installer familiar with drilling or other basic skills, depending on the attachment mechanism) and easily swapped once the panel mounting components are part of the door. In further exemplary embodiments, rather than providing mechanisms for retrofit of a door (not limited to interior doors), a custom order of a particular door can include such mounting hardware itself (on the door, or for example for certain magnetic designs, within aspects of the door, e.g., underneath a skin portion of the door), the hardware plus at least one supplemental panel, plural panels, etc.

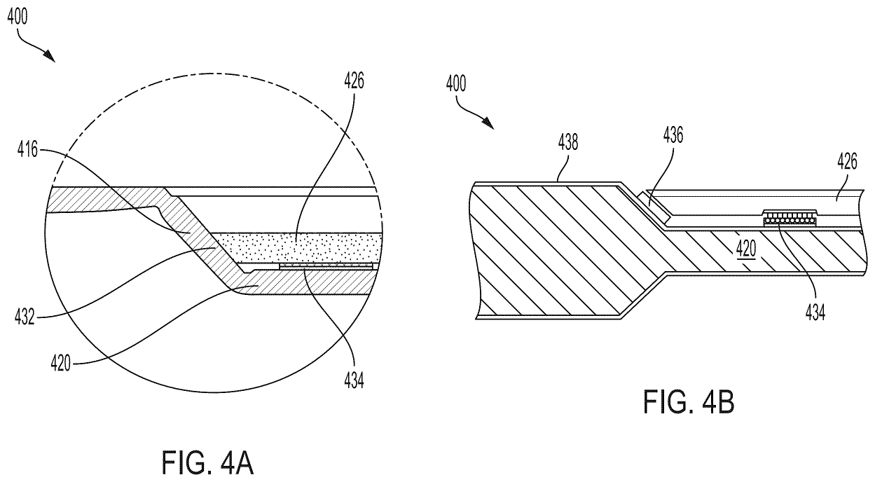

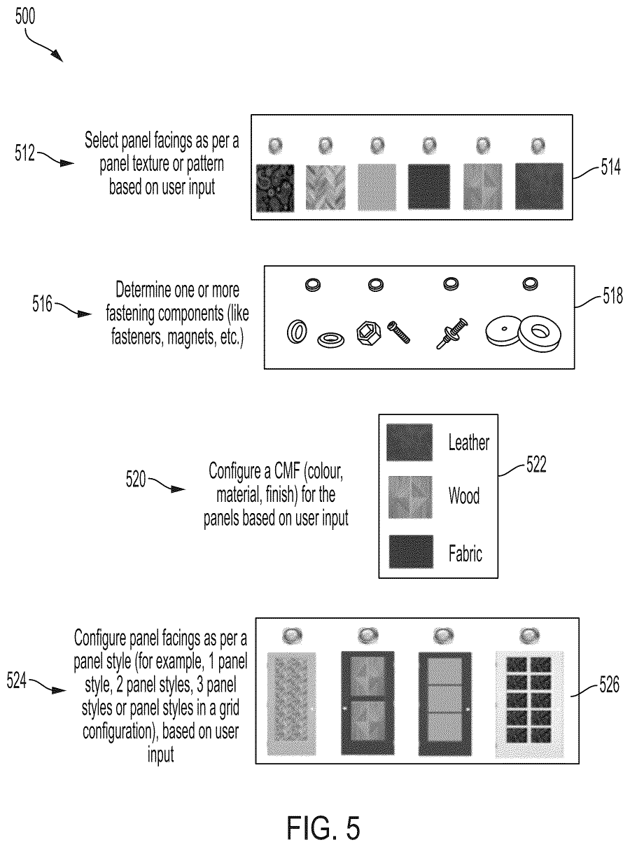

FIGS. 4A and 4B show two different nonlimiting examples of exemplary supplemental panel installations wherein the supplemental panel 426 is configured such that it complements the geometry/shape of the bevel 416 of the door 400. FIG. 4A illustrates a supplemental panel 426 recessed into flat panel portion 420, by virtue of its thickness (and consequently preserving the aesthetic of a recessed door panel in general), with a beveled secondary panel edge 432 that is complementary to the bevel geometry of door beveled portion 416 (providing a seamless or at least finished appearance). In this illustrated exemplary embodiment, an ultrathin adhesive or thin hook and loop fastener material 434 holds the supplemental panel only a small distance away from the base or bottom 420 of the primary panel portion for an optimal fit within that beveled portion.

FIG. 4B illustrates another exemplary embodiment at 400 of a supplemental panel 426 installed over a base portion 420 of the primary panel of the stock door. The illustrated exemplary embodiment shows a first mounting point 434 for the supplemental panel 426, as well as a second mounting component 436. The second mounting component, if provided, can be of the same type or different type mounting component as is provided at the first mounting point. Mounting component 436 can also be a customized piece matching the supplemental panel geometry to the door beveled portion 416, itself. Such component 436 can include adhesives, magnetic components, pins, screws or any other kind of fastener component, etc., but can also simply be a spacer, non-fastening pin, molded part, etc.

We note that in FIG. 4B, the supplemental panel is recessed, but less recessed than the supplemental panel of FIG. 4A. This need not be the case; and indeed, the panel may be more recessed as desired or may actually extend further away from the door, e.g., away from non-beveled surface 438 of the door to protrude from the door itself, at least in one or more places, in general or e.g., as a rack or mounting point, as a whiteboard or display screen or as any other device described herein. Further, any primary or secondary panel that is replaceable herein can include additional contouring to mimic or differentiate from the overall style of the door, e.g., including stile or rail components matching or differing from other panels or door aspects, or including any other desired contours, patterns, fabrics, decorative or otherwise (e.g., sound dampening, painted surfaces, etc.).

In further exemplary embodiments, a web interface provides for an ordering system that identifies a desired door design and allows for customization or personalization as described above or further in the present disclosure. An exemplary flowchart and interface is illustrated generally at 500, with parallel flow chart elements and user interface (UI) selectable aspects shown side by side. We note that the user interface may first be provisioned to allow selection or identification of a stock door itself, such that a supplemental panel can be customized for that particular door. At step 512, a user interface (514) is configured to allow user selection of panel facings for a supplemental panel according to texture, pattern, functionality, etc., based on user input. At step 516, a user interface (518) is configured to allow user selection of fastener types (and incidentally may also include ordering of any relevant templates, etc., for such installation). At 520, a user interface (522) is configured to allow selection of a color material or finish for the supplemental panel (though this user interface may also be configured to allow for further selection of any stylistic, material, or functional aspects, as desired). At 524, a user interface (526) is configured to allow selections identifying door type (if such isn't already established in prior steps) and/or panel placement on a particular door or a selection of a supplemental door panel for an unidentified or universal door type. Further, where multiple supplemental panels are selected, the user interface may be configured to provide different supplemental panel styles/functionality, etc. for different panels on the same door.

It should further be noted that a co-pending application relates to facile replacement of a supplemental panel for a door (without the need to disassemble the door frame), such that selection of a (primary or secondary) door panel can also be made with reference to an identified door, e.g, where that door is a stile and rail type door that includes a removable retaining component, which can be, e.g., a gasket, one or more shims, pins or other edge material for easy replacement of a primary door panel that are complementary to holes or grooves in the door around the panel and which are configured to facilitate removal of the retaining component and replaceable panel, without disassembly of any door frame components.

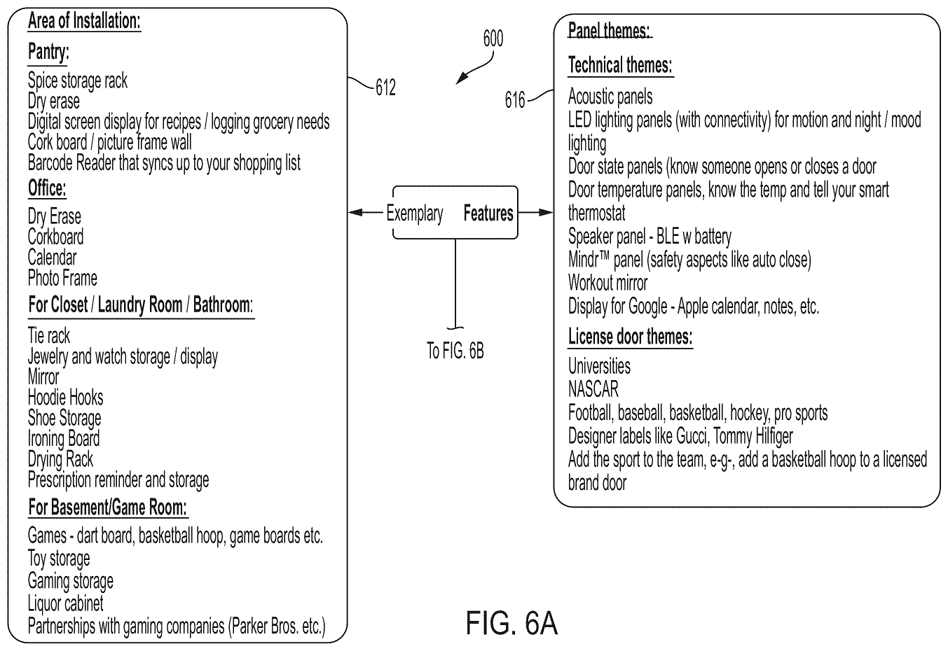

In exemplary embodiments described herein, a supplemental panel (or indeed an easily replaced primary panel) may include a number of non-limiting styles or configurations. FIG. 6 lists a number of exemplary features that may be configured for a panel that is custom to a particular stock door or that is universal and retrofitted. Box 612 describes exemplary areas of installation, including a pantry (space storage rack, dry erase board, digital screen display, e.g., for recipes, groceries, a cork board, a picture frame, a barcode reader for shopping lists, etc.), an office space (e.g., a dry erase board, a corkboard, a calendar, a photo frame, a display, etc.), a closet, laundry room or bathroom (e.g., including a rack, such as a tie rack, jewelry or watch displays or winders, a mirror or reflective material, handle hooks, shoe storage, an ironing board, a drying rack, prescription reminders, etc., and a basement or game room (with games, such as a dart board, basketball hoop, game boards, equipment racks, toy storage, game storage, displays, etc.), or indeed any other storage, such as locked cabinets or storage, gun safes, liquor cabinets, etc.

Box 614 in FIG. 6 illustrates various additional exemplary secondary panel configurations (or indeed primary panel configurations for the co-pending application related hereto), including vending, glass, shelves, hangers, shadow/display boxes, an ant farm, an electric mirror, a white noise generator, smart glass, a smart display or other display panel, powered ventilation or air circulation devices, an electronic message board, a battery or battery panel, e.g., for lighting, network bridges or routers or other data relay, wireless power transmission, sound, video display, recharging other batteries, or any powered door functionality otherwise provided by smart doors, a fish tank, a peg board, a slot board, a clip board or easel, seasonal decoration hangers, a sticker board, a picture holder, a tack board, a wall organizer, etc.

Box 616 in FIG. 6 illustrates additional exemplary panel features, including acoustic panels (e.g., for audiophile sound conditioning of a room or for general dampening of noise), projectors, LED or other light source lighting panels, motion sensitive panels, which may e.g. relate to the former light source aspect, sensors in general, door state panels (door open/closed), temperature sensors, smoke or other gas detectors, speakers (any of the devices described herein may also include integrated or mountable batteries or other power sources), auto close or other door movement devices, workout mirrors or displays, platform specific devices, licensed themes, e.g., via a display, AI interfaces, including displays, speakers, projection devices, etc.

The foregoing description of the exemplary embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A door panel system, comprising:
a door including plural stiles and rails;
a primary panel configured to at least partially nest within grooves that are provided between the plural stiles and rails; and
a primary panel retaining component provided in at least discrete plural positions on the plural stiles or rails, wherein the retaining component is configured with a protrusion to engage a groove or hole at those at least plural positions, allowing replacement of the primary panel without disassembly of the stiles and rails themselves.

2. A door panel system in accordance with claim 1, wherein the retaining component includes at least two protrusions to engage at least two grooves or holes at the at least plural positions, allowing replacement of the primary panel without disassembly of the stiles and rails themselves.

3. A door panel system in accordance with claim 2, wherein at least one of the at least two protrusions is an elongated rail on the primary panel received in a groove on one or more of the stiles and rails.

4. A door panel system in accordance with claim 1, further comprising a replacement primary panel configured to replace the existing primary panel, wherein the replacement primary panel includes electronics.

5. A door panel system in accordance with claim 4, wherein the replacement primary panel includes data transfer, data relay or data connectivity hardware.

6. A door panel system in accordance with claim 1, further comprising a replacement primary panel configured to replace the existing primary panel, wherein the replacement panel includes a battery.

7. A door panel system in accordance with claim 1, further comprising a replacement primary panel configured to replace the existing primary panel, wherein the replacement primary panel includes a display.

8. A door panel system in accordance with claim 1, further comprising a replacement primary panel configured to replace the existing primary panel, wherein the replacement primary panel includes a mount or device holding aspect.

9. A door panel system in accordance with claim 1, further comprising a replacement primary panel configured to replace the existing primary panel, wherein the replacement primary panel includes decorative or functional surfaces, such as printed surfaces, fabric covers, market boards, or tack boards.

10. A door panel system in accordance with claim 1, further comprising a replacement primary panel configured to replace the existing primary panel, wherein the replacement primary panel includes additional stiles and and/or rails to create a multi-panel door.

11. A door panel system in accordance with claim 1, wherein a computer user interface, operated by a processor, provides for selection of a particular door style or model and populates options for a user for replaceable panels.

12. A door panel system in accordance with claim 11, wherein the user interface allows for selection of replacement panels according to retaining member type.

13. A door panel system in accordance with claim 11, wherein the user interface allows for selection of panels according to function.

14. A door panel system in accordance with claim 11, wherein the user interface allows for varied selection of replacement panels according to a particular door, based upon one or more of design, fastener type, material, texture, fit or function.

15. A door panel system in accordance with claim 11, wherein the user interface is also configured to permit selection of one or more supplemental panels for the door.

16. A method for replacing a door panel, comprising:
providing a door including plural stiles and rails;
providing a primary panel configured to at least partially nest within grooves that are provided between the plural stiles and rails;
removing a retaining component provided in at least plural positions on the plural stiles or rails, wherein the retaining component is configured with a protrusion to engage a groove or hole at those at least plural positions, allowing replacement of the primary panel without disassembly of the stiles and rails themselves;
replacing the primary panel with a replacement panel; and
replacing or reinstalling the retaining component to secure the replacement panel in place.

17. A method in accordance with claim 16, further replacing the primary panel with a replacement panel that includes electronics; a battery; a display; or data transfer data relay or data connectivity hardware.

18. A method in accordance with claim 16, further replacing the primary panel with a replacement panel that includes a mount or device holding aspect.

19. A method in accordance with claim 16, wherein a computer user interface, operated by a processor, provides for selection of a particular door style or model and populates options for a user for replaceable panels.

20. A method in accordance with claim 19, wherein the user interface allows for selection of replacement panels according to function.

21. A method in accordance with claim 19, wherein the user interface allows for selection of replacement panels according to a particular door, based upon one or more of design, fastener type, material, texture, fit or function.

22. A method in accordance with claim 19, wherein the user interface is also configured to permit selection of one or more supplemental panels for the door.
